(19) United States
(12) Patent Application Publication
(10) Pub. No.: US 2005/0021719 A1
(43) Pub. Date: Jan. 27, 2005

(54) Physical distribution management server, physical distribution service transaction system, physical distribution service transaction method, recording medium, and computer data signal

(75) Inventor: Kazuhiro Hara, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 10/845,141

(22) Filed: May 14, 2004

(30) Foreign Application Priority Data
May 14, 2003 (JP) 2003-135666

(51) Int. Cl. G06F 15/173

(52) U.S. Cl. 709/223

(57) ABSTRACT

A transport management server receives service provision information that includes data that specifies a transport service provider and data indicating transport service content by the service provider, from a terminal of a transport service user, via a network, and retains the information so that it can be browsed. The terminals of the transport service provider and the transport service user, receive at least one of, transport service information, insurance money performance data, and fee payment performance data, from the transport management server, and displays it, in order to search a transport service that can obtain agreement towards a demand and supply condition, by both the transport service provider and the transport service user.

### BACKGROUND OF THE INVENTION

1. Field of the Invention

The present invention relates to a physical distribution management server used in physical distribution service and transport service, such as home delivery service, and physical distribution service transaction system and physical distribution service transaction method, etc., using this physical distribution management server.

2. Description of the Related Art

Conventionally, from the aspect of convenience, home delivery service is used as a means for physical distribution. Especially in mail order and the like, physical distribution service such as home delivery service is heavily used.

In recent years, concerning circulation of goods that is not a tangible entity, such as distribution of music, business performed by using communication network from order placement to reception, without any intervention of transfer of an information recording medium, which is a tangible entity, is spreading.

However, concerning circulation of goods that is a tangible entity, it is physically impossible to cover everything by using a communication network and a computer, and a transport service, such as a home delivery service is imperative. Therefore, improvement of convenience, such as further simplicity and lower costs, is sought, and various proposals towards these requests are made.

For example, a system for carrying out selection of a delivery agency, based on a request from a collection requestor, in order for an adequate delivery agency to effectively collect goods to be delivered, is proposed. This kind of system is disclosed in for example, Unexamined Japanese Patent Application KOKAI Publication No. 2002-092112. In this system, a database that stores various registration content concerning delivery agencies, is set at a service center. Then, a user accesses to the service center by the Internet, using a portable terminal or a personal computer. The service center supplies a screen that urges the user to input collection condition of the goods to be delivered, in accordance with the access. When the user inputs the necessary information and sends it to the service center, the service center selects agencies suitable for collecting the goods of the user that is to be delivered, based on information collected by each agency, and presents the selected agencies to the user. When the user selects an agency, collecting of goods to be delivered, is carried out, based on the selection.

Also, a system which can create a delivery slip and carry out conversion of delivery fees, by structuring delivery slip creating means and a POS register as one system, and carries out processing concerning delivery and processing concerning sales by the POS register, is proposed. This system is disclosed in for example, Unexamined Japanese Patent Application KOKAI Publication No. 2001-319276. In this system, because delivery slip creating processing is carried out by only the POS register, reducing of installing space can be reduced. Further, because reception input of a delivery, delivery slip creation, and settlement can be carried out by the POS register, processing time can be reduced. Also, by using customer cards and customer master files, reduction of input processing time becomes possible.

A system where the customer obtains predetermined information via the Internet, and which promptly creates various slips and documents for requesting home delivery, is also proposed. This system is disclosed in for example, Unexamined Japanese Patent Application KOKAI Publication No. 2002-205821. This system is structured so that a customer terminal, a server of a delivery company and a host computer, and an auction site are connected by the Internet. The customer terminal carries out processing for obtaining predetermined various slips, dialogically, in accordance with operation of various software keys on a browser screen, created by the delivery company. The Internet server of the delivery company sends information of scheduled date for making payment to the customer, of the fee collected when delivering a package to the package recipient.

Also, a system for selecting an adequate delivery agent easily and effectively, based on transport condition that a sender requests, is proposed. This system is disclosed in for example, Unexamined Japanese Patent Application KOKAI Publication No. 2002-274651. In this system, a user terminal sends sender data and receiver data to a management server. The management server sends screen data for designating transport conditions to the user terminal. After receiving information designating transport conditions from the user terminal, the management server selects a delivery agent that matches with the designated transport condition, and sends information concerning transport, such as, transport fee of the selected delivery agent and transport content, etc., to the user terminal. When a delivery agent is determined, the user terminal print outputs a delivery slip. An agent terminal registers or changes data concerning transport, registered in the management server, accordingly.

A system which accepts reservation of delivery service usage on the Web, for providing a rapid and high quality delivery system, is also proposed. This system is disclosed in for example, Unexamined Japanese Patent Application KOKAI Publication No. 2002-255345. In this system, a Web server receives pick-up request, re-delivery request, and delivery date and time changing request, regardless of business hours, and directly sends request information to a representing physical distribution base server, or a delivery representative terminal, based on automatic searching function of the Web server. The Web server sends data of requested delivery date and time via the Internet, to a delivery destination E-mail address, based on the pick-up request information. The person who receives data sends a delivery date and time changing request, using a terminal to the Web server.

Also, a system that carries out home-delivery along a way of an individual going on a trip, etc., is proposed. This system is disclosed in for example, Unexamined Japanese Patent Application KOKAI Publication No. 2002-063395. In this system, people who transfer for commute, or people who transfer at a fixed route on a daily basis, are organized as deliverers. Information of transfer of the deliverers is collected in advance, and registered to a computer A. In a case where delivery of a package is accepted, information of the delivery subject is registered to another computer B. By referring to information of the delivery subject registered in the computer B and information of the deliverer registered in the computer A, an adequate package deliverer is selected, and transport is requested.

In auction sites, it is inconvenient that the individual who participates in the auction has to search a home-delivery agent for transferring goods. To solve this problem, there is a system for improving convenience, by automatically sending registered information of the purchaser of goods and the seller of the goods, to a home-delivery agent. This system is disclosed in for example, Unexamined Japanese Patent Application KOKAI Publication No. 2003-036401. In this system, information of a plurality of home-delivery agents are displayed so that a home-delivery agent can be selected, on a home page of an auction site, and a home-delivery agent is decided, in accordance with the selection of the purchaser. The computer of the auction site sends information registered by the seller and the purchaser of the auction, towards the decided home-delivery agent.

However, to apply the systems disclosed in Unexamined Japanese Patent Application KOKAI Publication No. 2002-092112, Unexamined Japanese Patent Application KOKAI Publication No. 2001-319276, Unexamined Japanese Patent Application KOKAI Publication No. 2002-205821, Unexamined Japanese Patent Application KOKAI Publication No. 2002-274651, Unexamined Japanese Patent Application KOKAI Publication No. 2002-255345, and Unexamined Japanese Patent Application KOKAI Publication No. 2003-036401, to a case where home-delivery is carried out individually, it does not adapt well because the scale of the system and necessary facilities are too large, and conditions for premise differ greatly. The system disclosed in Unexamined Japanese Patent Application KOKAI Publication No. 2002-063395 focuses on carrying out home-delivery individually. However, points such as securement of safety of transport, and insurance in a case where an accident occurs, is not considered.

### SUMMARY OF THE INVENTION

The present invention has been made in consideration of the above, and an object is to provide a physical distribution management server, a physical distribution service transaction system, and a physical distribution service transaction method, etc., for realizing a transport service that is suitable in a case of carrying out delivery individually, a user being protected by securement of safety of transport and insurance in a case where an accident occurs, more conveniently and at a lower cost.

To achieve the above object, a physical distribution management sever comprises:
a transport service information reception unit that receives service provision information that includes data for specifying a transport service provider and data indicating transport service content by the service provider, via a network, and retains the information so that it can be browsed via said network;
an acknowledgement unit that acknowledges a transport service that is determined to be used by a transport service user, out of the transport services indicated by the service provision information, based on predetermined information received via the network;
an information management unit that deletes transport service provision information according to the acknowledged service and service provision information that has passed a predetermined retainment period, from the service provision information retained by the transport service information reception unit;
an insurance performance management unit that receives insurance performance data that indicates performance of claim and/or payment of insurance money granted concerning each transport service, based on the usage situation of transport service by the transport service user, via the network, and retains the data so that it can be browsed via the network, and
transport fee payment performance management unit that retains data indicating payment performance of transport fee towards the transport service provider, according to each transport service user, so that it can be browsed, by the network.

The transport service information reception unit may receive the service provision information that includes data that specifies a natural person that desires to carry out transport service individually, as the transport service provider, and also indicates contacting method with the natural person, and data indicating transport service content by the natural person.

Data that specifies the natural person, and indicates the contacting method with the natural person, may include e-mail address.

Data indicating the transport service content by the natural person, may include any one of data of domestic and overseas business trips by the natural person, data indicating transfer destination, including transfer by trips, data indicating size and/or weight of goods that can be transported, and data indicating delivery location and/or way of delivery of goods.

The acknowledgement unit may receive information concerning the transport service that has reached an agreement between the transport service provider and the transport service user, from a terminal of the transport provider, and may acknowledge the transport service whose usage is determined, based on the received information.

The information management unit may handle transport information whose scheduled departure date according to transfer of the transport service provider, domestically and overseas, has passed, as service provision information that has passed the predetermined retainment period.

The insurance performance management unit may receive the transport insurance performance data from a computer of an insurance company, via a network.

A physical distribution service transaction system according to a second aspect of the present invention, has
a physical distribution management server that comprises:
   a transport service information reception unit that receives service provision information that includes data for specifying a transport service provider and data indicating transport service content by the service provider, via a network, and retains the information so that it can be browsed via the network;
   an acknowledgement unit that acknowledges a transport service that is determined to be used by a transport service user, out of the transport services indicated by the service provision information, based on predetermined information received via the network;
   an information management unit that deletes transport service provision information according to the acknowledged service and service provision information that has passed a predetermined retainment period, from the service provision information retained by the transport service information reception unit;
   an insurance performance management unit that receives insurance performance data that indicates performance of claim and/or payment of insurance money granted concerning each transport service, based on the usage situation of transport service by the transport service user, via the network, and retains the data so that it can be browsed via the network, and
   transport fee payment performance management unit that retains data indicating payment performance of transport fee towards the transport service provider, according to each transport service user, so that it can be browsed, by the network,
a computer of a transport service provider that sends the transport service information to the physical distribution management server, and receives and displays at least one of, transport service information, insurance money performance data, and fee payment performance data, retained by the physical distribution management server, in order to search a transport service that can obtain agreement towards a demand and supply condition, by both the transport service provider and the transport service user, and
a computer of a transport service user that receives and displays at least one of, transport service information, insurance money performance data, and fee payment performance data, retained by the physical distribution management server, in order to search a transport service that can obtain agreement towards a demand and supply condition, by both the transport service provider and the transport service user.

The transport service user may include a natural person that carries out transport service individually.

The computer of the transport service provider and the computer of the transport service user, may use e-mail to search a transport service that can obtain agreement towards a demand and supply condition, by both the transport service provider and the transport service user.

A physical distribution service transaction method according to a third aspect of the present invention, comprises:
a step of sending service provision information that includes data for specifying a transport service provider, and data indicating the content of transport service by the service provider, to a physical distribution management sever, via a network;
a step of receiving the service provision information via the network, and retaining the information so that it can be browsed via the network;
a step of acknowledging a transport service that is determined to be used by a transport service user, out of the transport services indicated by the service provision information, based on predetermined information received via the network;
a step of deleting transport service provision information according to the acknowledged transport service and service provision information that has passed a predetermined retainment period, from the retained service provision information;
a step of receiving insurance money performance data that indicates performance of claim and/or payment of insurance money granted concerning each transport service, based on the usage situation of transport service by the transport service user, via the network, and retaining the data so that it can be browsed via the network, and
a step of receiving and displaying at least one of, transport service information, insurance money performance data, and fee payment performance data, retained by the physical distribution management server, in order to search a transport service that can obtain agreement towards a demand and supply condition, by both the transport service provider and the transport service user.

A computer readable recording medium according to a fourth aspect of the present invention, stores a program to control a computer to execute:
a step of receiving service provision information that includes data for specifying the transport service provider, and data indicating the content of transport service by the service provider, via a network, and retains the information so that it can be browsed via the network;
a step of acknowledging a transport service that is determined to be used by a transport service user, out of the transport services indicated by the service provision information, based on predetermined information received via the network;
a step of deleting transport service provision information according to the acknowledged transport service and service provision information that has passed a predetermined retainment period, from the retained service provision information;
a step of receiving insurance money performance data that indicates performance of claim and/or payment of insurance money granted concerning each transport service; based on the usage situation of transport service by the transport service user, via the network, and retaining the data so that it can be browsed via the network, and
a step of retaining data indicating payment performance of transport fee towards the transport service provider, according to each transport service user, so that it can be browsed via the network.

A computer data signal embedded in a carrier wave according to a fifth aspect of the present invention, represents a program for controlling a computer to execute:
a step of receiving service provision information that includes data for specifying the transport service provider, and data indicating the content of transport service by the service provider, via a network, and retains the information so that it can be browsed via the network;
a step of acknowledging a transport service that is determined to be used by a transport service user, out of the transport services indicated by the service provision information, based on predetermined information received via the network;
a step of deleting transport service provision information according to the acknowledged transport service and service provision information that has passed a predetermined retainment period, from the retained service provision information;
a step of receiving insurance money performance data that indicates performance of claim and/or payment of insurance money granted concerning each transport service; based on the usage situation of transport service by the transport service user, via the network, and retaining the data so that it can be browsed via the network, and
a step of retaining data indicating payment performance of transport fee towards the transport service provider, according to each transport service user, so that it can be browsed via the network.

### BRIEF DESCRIPTION OF THE DRAWINGS

These objects and other objects and advantages of the present invention will become more apparent upon reading of the following detailed description and the accompanying drawings in which:

FIG. 1 is a diagram showing a system structure of a physical distribution service transaction system, according to an embodiment of the present invention;

FIG. 2 is a diagram showing a system structure of a transport management server used in the physical distribution service transaction system, in FIG. 1;

FIG. 3 is a diagram showing a system structure of a terminal of a transport service provider used in the physical distribution service transaction system, in FIG. 1;

FIG. 4 is a diagram showing a system structure of a terminal of a transport service user used in the physical distribution service transaction system, in FIG. 1;

FIG. 5 is a flowchart for describing transport service information registration processing;

FIG. 6 is a flowchart for describing transport service information browsing processing, and

FIG. 7 is a flowchart describing usage determination registration processing.

### DETAILED DESCRIPTION OF THE PREFERRED EMBODIMENT

An embodiment of the present invention will be described with reference to the drawings.

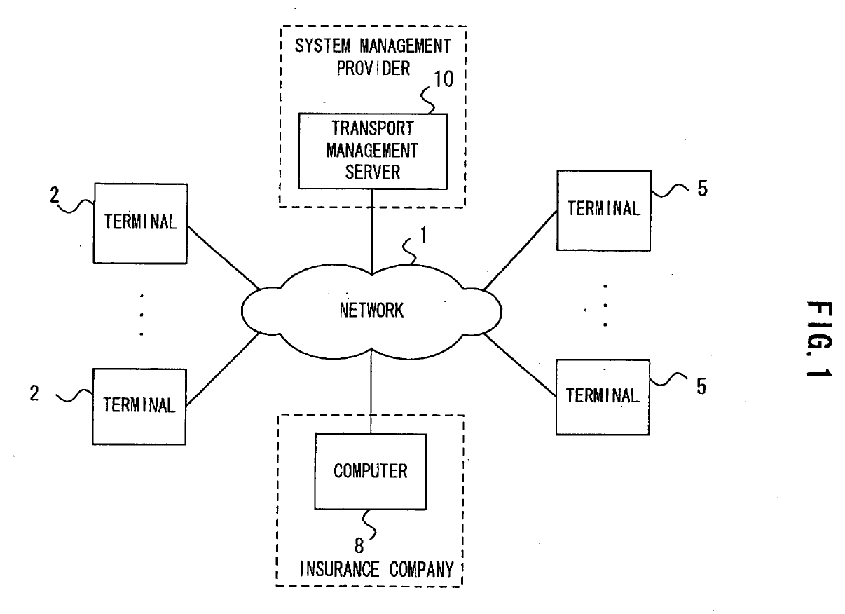

FIG. 1 is a diagram for describing a structure of a physical distribution service transaction system according to an embodiment of the present invention.

The physical distribution service transaction system comprises a terminal 2 of a person who desires provision of a transport service (hereinafter referred to as a transport service provider), a terminal 5 of a person who desires usage of a transport service (hereinafter referred to as a transport service user), a computer 8 of an insurance company, a transport management (service) server 10, which is under the management of a system management provider, and etc., each being connectable to a network 1, such as the Internet, etc. The network 1 includes wireless, cable, a dedicated line, a public line, the Internet, a LAN (Local Area Network), and a WAN (Wide Area Network), etc. In the present embodiment, the transport service includes home-delivery service. The system of the present embodiment is especially adequate concerning home-delivery service that carries out individual home-delivering. The system management provider in the present embodiment, is for example, one that performs management of the physical distribution service transaction system according to the present invention as a business. The system management provider certifies a natural person, etc., who desires to individually perform delivery service and a natural person, etc., who desires to individually use the delivery service, as a member of the present system, under a condition of, for example, paying membership fees, and following agreements. Then, the system management provider notifies a URL of a transport management server 10 to these members, and allots a log-in ID. These members are the transport service providers and the transport service users. The members may be companies.

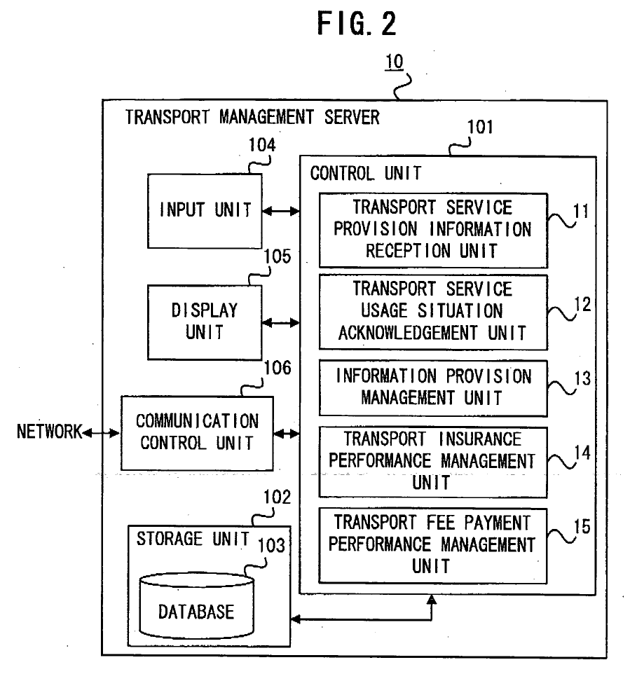

A structure example of the transport management server 10 is shown in FIG. 2. The transport management server 10 is structured of a general-purpose computer comprising a control unit 101, a storage unit 102, an input unit 104, a display unit 105, and a communication control unit 106, etc. The control unit 101 is structured of a CPU (Central Processing Unit), a ROM (Read Only Memory), and a RAM (Random Access Memory), and controls the entirety of the transport management server 10. The control unit 101 logically realizes a transport service provision information reception unit 11, a transport service usage situation acknowledgement unit 12, an information provision management unit 13, a transport insurance performance management unit 14, and a transport fee payment performance management unit 15, by reading and thereby executing an operational program, etc., that is stored in the storage unit 102 beforehand. The storage unit 102 is structured of a hard disk device, etc. The storage unit 102 stores operational programs for the control unit 101 to execute, and various data, etc., necessary for processing. The storage unit 102 comprises a database 103 that stores later described transfer service information, etc. The input unit 104 is structured of an input device, such as a keyboard, and a pointing device, etc., and sends the input data to the control unit 101. The display unit 105 is constituted of a display device, such as a CRT, and a liquid crystal display, and outputs various screens, etc., in accordance with instructions from the control unit 101. The communication control unit 106 carries out communication with other devices (terminal 2, terminal 5, and computer 8, etc.) via the network 1, in accordance with instructions from the control unit 101.

The transport service provision information reception unit 11 of the transport management server 10 receives transport service information, which includes data for respectively specifying each of the transport service providers (for example, name and e-mail address, etc., of the transport service provider), and data indicating the content of the transport service that the transport service provider provides, from the terminal 2 of the transport service provider, via the network 1. Then, the transport service provision information reception unit 11 retains the received transport service information, so that the browsers, who are members of the service provided by the system management providers, can browse the information via the network 1. Concretely, for example, the transport service provision information reception unit 11 stores the transport service information received from the terminal 2 to the database 103 of the storage unit 102. Then, the transport service provision information reception unit 11 reads the transport service information stored in the database 103, in accordance with a browsing request of transport information from a terminal 5, etc., of a member, and sends screen data that displays the read information to the terminal 5, etc., of the requester.

Data for specifying the service provider is also used, for example, as data showing the way of contact with the service provider. Data of the transport service content concerns transfer, such as domestic and overseas business trips and trips, etc., of the transport service provider, and includes any of, data indicating transfer destination, data indicating scheduled departure date and arrival date (or period of transfer), data indicating size and/or weight of goods that can be transported, data indicating delivery location and/or way of delivery of the goods to be transported. Data indicating the transport service content is data for the transport service user to concretely acknowledge the content of transport service that each transport service provider wishes to provide, and for determining whether a request for a delivery of goods is possible or not. This data may also be written in a foreign language, in accordance with the transport service content.

Concrete methods for transactions, such as auctions, etc., are arbitrary. For example, in a case where there is a browsing request of transport service information from the terminal 2, 5, the transport service provision information reception unit 11 supplies to the terminal 2,5 that is a requestor, a screen that displays transport service information that is stored in the database 103, whose content of predetermined items (for example, departure date, transfer destination, etc.) are the same, in an order from the lowest rate. Then, for example, the transport service user selects a requested transport service information from the browsed transport service information, and sends an e-mail requesting the transport service, to the e-mail address that the transport service information indicates. The transport service provider receives the e-mail requesting transport service, by using a terminal, and sends an e-mail that the request is accepted, to the address of the requester, when the transport service provider decides to accept the request. By this, an agreement that a transport service will be used, is made between the transport service user and the transport service provider.

The transport service usage situation acknowledgement unit 12 acknowledges the transport service that is decided to be used by the transport service user, concerning the service provision information retained by the transport service provision information reception unit 11 (namely, stored in the database 103), based on the information supplied via the network 1. Concretely, transactions, such as auctions, etc., concerning transport service is carried out, and in a case where an agreement to use a transport service is made between the transport service user and the transport service provider, the transport service provider sends predetermined data (usage determination data) concerning the transport service whose usage is determined, based on membership agreements, to the transport management server 10, using the terminal 2. Concretely, for example, the terminal 2 may connect to the transport management server 10, and send usage determination data including, data of transport service provider name, transport service user name, and sum of goods to be delivered. When the transport service usage situation acknowledgement unit 12 receives usage determination data from the terminal 2, it specifies the transport service information corresponding to the received usage determination data from the transport service information stored in the database 103, and generates usage situation data including predetermined information (for example, transport service provider name, transport date, transport destination, etc.) in the specified transport service information, and data such as the received transport service user name, and sum of goods to be transported, etc., and stores the data to the database 103.

The information provision management unit 13 deletes transport service information concerning transport service whose usage is acknowledged by the transport service usage situation acknowledgement unit 12, transport service information whose provision period has passed, and ends provision of these transport service information via the network 1. Concretely, for example, transport service information whose usage is acknowledged by the transport service usage situation acknowledgement unit 12 is deleted from database 103. Concerning each transport service information stored in the database 103, information whose departure term has already passed is detected by comparing, etc., data of the departure term and the present data obtained by an internal timer, and the detected transport service information is deleted from the database 103. By this, accidental confusion occurring by past transport service information that can no longer be used due to a contract being signed or expiration of a term, being provided, can be prevented. Also, effective operation of the system can be performed, by not retaining unnecessary data in the server, and occupying the memory.

The transport insurance performance management unit 14 receives data indicating performance of claim and/or payment of insurance money (insurance money performance data) of the insurance granted by the system management provider, concerning each transport service that the usage situation data stored in the database 103 indicates, via the network 1, and retains the received insurance performance data, so that the browsers, who are members, can browse the data via the network 1. Concretely, in the operation of the present system, it is set so that the system management provider covers insurance at the burden of the transport service user, in accordance with the usage situation of transport service (sum of transport goods, etc.). The transport service user pays the insurance fee to the account of the system management provider. Then, in a case where the transport service provider loses or breaks the transport goods, insurance money is paid to the transport service user, from the insurance company that handled insurance, based on a claim from the transport service user. The representative of the insurance company that paid the insurance money sends from the computer 8 of the insurance company, insurance money performance data, which includes for example, information concerning insurance money claim (claimer of insurance money, claim date, claim content, etc.) and information concerning payment (insurance company name, payment amount, etc.), to the transport management server 10. The transport insurance performance management unit 14 receives insurance money performance data from the computer 8 of the insurance company, and stores the data to the database 103. Then, the transport insurance performance management unit 14 reads insurance money performance data stored in the database 103, in accordance with a browsing request of insurance money performance data, from the terminal 2, 5 of the member, and sends screen data for displaying the read information to the terminal 2, 5 of the requestor. By browsing at any time, the performance data of claim and payment of insurance money, via the network 1, using the terminal 2,5, the member can determine the safeness of a transport service, according to each transport service provider, based on the content of the insurance money performance data. Also, in case the transport goods is lost, broke, or soiled, the damage is covered by insurance.

The transport fee payment performance management unit 15 receives data indicating payment performance of transport fee (fee payment performance data) towards the transport service provider, according to each transport service user, via the network 1, and retains the received insurance performance data so that the browser, who is a member, can browse the data via the network 1. Concretely, the transport fee payment performance management unit 15 receives for example, performance data of payment of transport fee, which includes for example, name of transport service user, who is the payer of the fee, and fee, etc., from the terminal 2 of the transport service provider who accepted transport fee from a transport service user, and stores the data to the database 103. Then, the transport fee payment performance management unit 15 reads the payment performance data stored in the database 103, in accordance with a browsing request of data of the payment performance of the transport fee, from the terminal 2, 5 of the member, and sends screen data that displays the read information, to the terminal 2, 5, of the requester. By browsing the payment performance data of the transport fee, using the terminal 2, via the network 1, the transport service provider can determine whether to accept a request for transport from the transport service user, based on the content of the payment performance data.

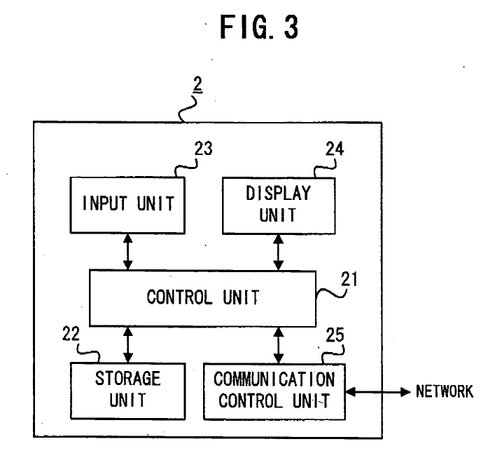

The terminal 2 of the transport service provider is constituted of, for example, as shown in FIG. 3, a general computer that comprises a control unit 21, a storage unit 22, an input unit 23, a display unit 24, and a communication control unit 25, etc.

The control unit 21 includes a CPU, a RAM, and a ROM, etc., and performs processing of connecting to the transport management server 10, sending the transport service information and registering the information, processing of sending a browsing request of various data (transport service information, transport insurance performance data, and transport fee payment performance data, etc.) registered in the database 103, receiving the requested data, and displaying the data to the display unit 24, processing of accepting input of data concerning transport service whose usage is determined, and sending usage determination data based on the input data to the transport management server 10, and processing of sending and receiving e-mail, so that both the transport service provider and the transport service user reach agreement under a demand and supply condition, etc., by reading and executing operational programs, etc., that are pre-stored in the storage unit 22.

The storage unit 22 is structured of a hard disk device, etc. The storage unit 22 stores operational programs for the control unit 21 to execute, and various data, etc., necessary for processing.

The input unit 23 is structured of an input device, such as a keyboard, and a pointing device, etc., and sends the input data to the control unit 21.

The display unit 24 is structured of a display device, such as a CRT, and a liquid crystal display device, etc., and outputs various screens, etc., in accordance with instructions from the control unit 21.

The communication control unit 25 controls communication with other devices, via the network 1, in accordance with instructions from the control unit 21.

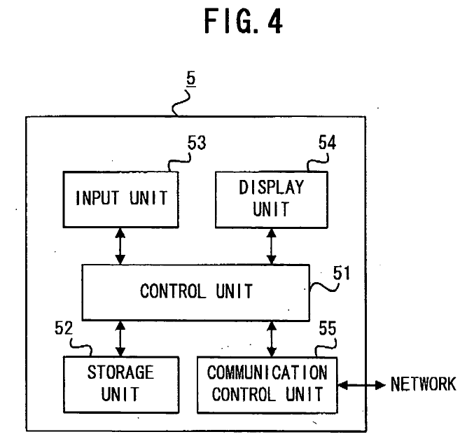

The terminal 5 of the transport service user, for example, as shown in FIG. 4, is structured of a general computer that comprises a control unit 51, a storage unit 52, an input unit 53, a display unit 54, and a communication control unit 55, etc.

The control unit 51 includes a CPU, a RAM, a ROM, etc., and performs processing of sending a browsing request of various data (transport service information, transport insurance performance data, and transport fee payment performance data, etc.) registered in the database 103, receiving the requested data, and displaying the data to the display unit 54, and processing of sending and receiving e-mail, so that both the transport service provider and the transport service user reach agreement under a demand and supply condition, concerning usage of the transport service information, by reading and executing operational programs, etc., that are pre-stored in the storage unit 52.

The storage unit 52 is structured of a hard disk device, etc. The storage unit 52 stores operational programs for the control unit 51 to execute, and various data, etc., necessary for processing.

The input unit 53 is structured of an input device, such as a keyboard, and a pointing device, etc., and sends the input data to the control unit 51.

The display unit 54 is structured of a display device, such as a CRT, and a liquid crystal display device, etc., and outputs various screens, etc., in accordance with instructions from the control unit 51.

The communication control unit 55 controls communication with other devices, via the network 1, in accordance with instructions from the control unit 51.

The computer 8 of the insurance company comprises a control unit (including a CPU, a RAM, and a ROM, etc.), a storage unit (including a HDD), an input unit (including a keyboard, and a mouse), a display unit (including a CRT, and a liquid crystal display), and a communication control unit, etc. The control unit of the computer 8 performs processing of connecting to the transport management server 10, and sending performance data of claim and payment of insurance money, by reading and executing operation programs, etc., that are pre-stored in the storage unit.

Next, operation of the physical distribution service transaction system according to the embodiment of the present invention will be described.

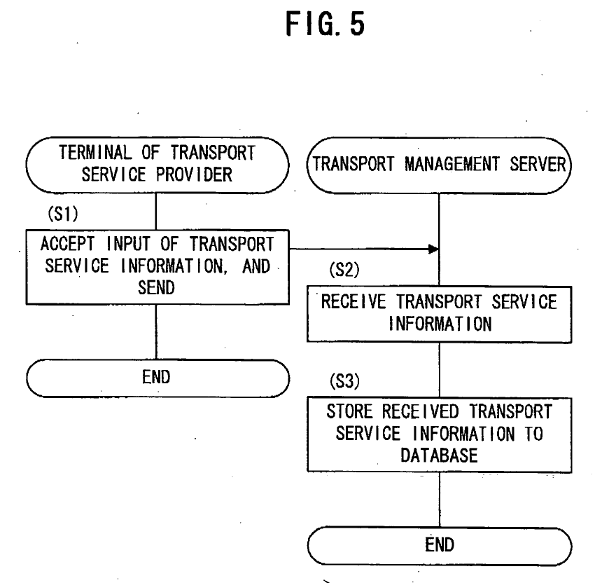

First, transport service information registering processing in a scene where the transport service information concerning the transport service that the transport service provider wishes to provide, is registered to the transport service management server 10, will be described with reference to FIG. 5.

The terminal 2 of the transport service provider accepts input of transport service information, in accordance with input operation of the transport service provider, and sends the input transport service information together with a register request, to the transport management server 10, via the network 1 (step S1).

The control unit 101 of the transport management server 10 receives the register request and transport service information from the terminal 2 of the transport service provider (step S2), and stores the received transport service information to the database 103 (step S3).

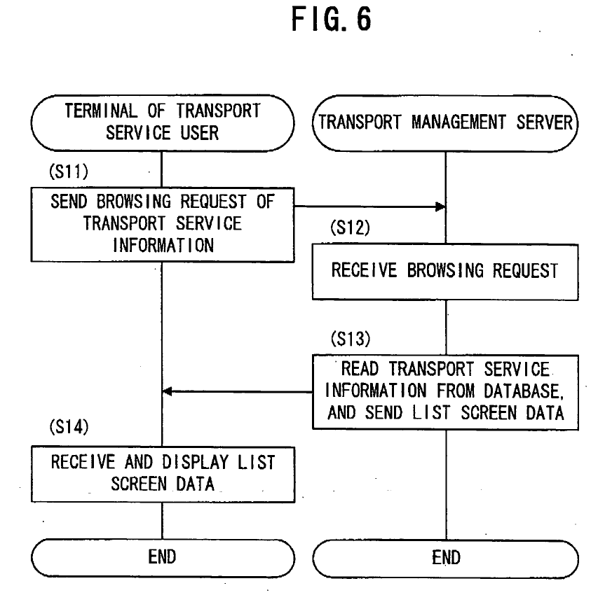

Next, transport service information browsing processing in a scene where transport service information registered in the transport management server 10, is browsed by the transport service user, will be described with reference to FIG. 6.

The terminal 5 of the transport service user sends a browsing request of transport service information to the transport management server 10, via the network 1, in accordance with input operation of the transport service user (step S11).

When the control unit 101 of the transport management server 10 receives the browsing request from the terminal 5 of the transport service user (step S12), the control unit 101 reads the transport service information registered in the database 103, and for example, generates screen data that displays the read transport service information in a list, and sends the data to the terminal 5 of the requester (step S113).

The terminal 5 of the transport service user receives and displays the list screen data of the transport service information (step S14).

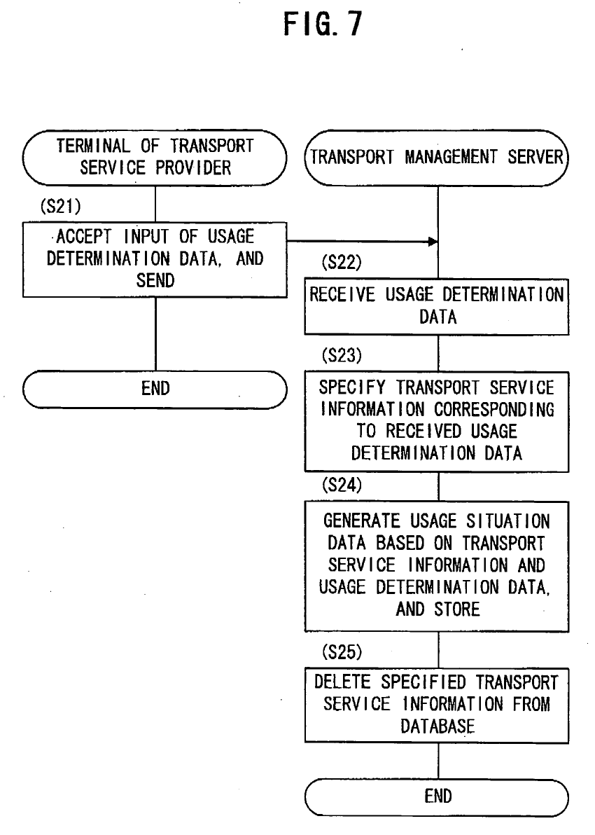

Next, usage determination registration processing in a scene where usage of a transport service is determined (transaction is established) between the transport service user and the transport service provider, will be described with reference to FIG. 7.

The terminal 2 of the transport service provider accepts input of usage determination data, including a transport service provider name, a transport service user name, and sum of goods to be transported, etc., and sends the input usage determination data, together with a notification that usage of transport service is determined, to the transfer management server 10 (step S21).

When the control unit 101 of the transport management server 10 receives the usage determination data from the terminal 2 (step S22), the control unit 101 searches for transport service information that corresponds to the received usage determination data, from the transport service information stored in the database 103, setting the transport service provider name, etc., that the usage determination data indicates, as the key, and specifies the transport service information that corresponds to the received usage determination data (step S23). Then, the control unit 101 generates usage situation data, based on the specified transport service information and received usage determination data, and stores it to the database 103 (step S24). Here, for example, usage situation data that includes predetermined information (for example, transport service provider name, transport date, and transport destination, etc.) in the specified transport service information, and received data of transport service user name, and sum of goods to be transported, etc., may be generated.

Next, the control unit 101 deletes the transport service information specified in step S23, from the database 103 (step S25).

According to the system of the present invention, the transport service provider and the transport service user can search/select a transport service that both the provider and user can reach an agreement under a demand and supply condition, using respective computers, by referring to various data (transport service information, transport insurance performance data, transport fee payment performance data, etc.) retained in the database 103 of the transport management server 10.

The transport service usage situation acknowledgement unit 12 may carry out processing for covering insurance, concerning transport service whose usage is determined. For example, the transport service usage situation acknowledgement unit 12 may determined the content of insurance (type of insurance, insurance company, and insurance premium, etc.) by referring to an insurance table that correlates data of goods, and sum of goods, etc., and data of insurance content. The insurance table is set beforehand by the system management provider, based on the sum of transport goods, etc., indicated by the usage situation data. An e-mail requesting that the insurance fee to be paid to a designated account, may be sent to the e-mail address of the transport service user. Application for insurance may be carried out by sending data concerning application for insurance (type of insurance, name of insured person, and insurance premium, etc.), towards the computer of the insurance company.

In the system of the present embodiment, in a case where the transport service provider is an individual, it can be expected that goods can be delivered to a destined place, at a lower cost than, by relegating to a general transporter.

Also, for example, in a case where the transport service provider and the transport service user are at a near place, such as the same or neighboring company, building, or apartment, because transport goods can be handed to the transport service provider by hand, a request for transport can be carried out rapidly. By this, it is possible to deliver goods to a requested destination faster, than by relegating to a general transporter.

Further, transport service providers who have many opportunities to go on domestic business trips and overseas business trips, can earn extra money by using the system of the present invention.

Also, if the user of the system of the present invention spreads, and members of the present system increase, system management providers can expect an increase in membership fee and advertising revenue.

According to the present invention, a transport service that is suitable in a case where delivery is carried out individually, the user is protected by securing safety of transport, and insurance in a case where an accident occurs, and is simple and low-cost, can be realized.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2003-135666 filed on May 14, 2003 and including specification, claims, drawings and summary. The disclosure of the above Japanese Patent Application is incorporated herein by reference in its entirety.

1. A physical distribution management sever comprising:
a transport service information reception unit that receives service provision information that includes data for specifying a transport service provider and data indicating transport service content by the service provider, via a network, and retains the information so that it can be browsed via said network;
an acknowledgement unit that acknowledges a transport service that is determined to be used by a transport service user, out of the transport services indicated by the service provision information, based on predetermined information received via said network;
an information management unit that deletes transport service provision information according to said acknowledged service and service provision information that has passed a predetermined retainment period, from the service provision information retained by said transport service information reception unit;
an insurance performance management unit that receives insurance performance data that indicates performance of claim and/or payment of insurance money granted concerning each transport service, based on the usage situation of transport service by the transport service user, via said network, and retains the data so that it can be browsed via said network, and
transport fee payment performance management unit that retains data indicating payment performance of transport fee towards the transport service provider, according to each transport service user, so that it can be browsed, by said network.

2. The physical distribution management server according to claim 1, wherein said transport service information reception unit receives said service provision information that includes data that specifies a natural person that desires to carry out transport service individually, as said transport service provider, and also indicates contacting method with the natural person, and data indicating transport service content by said natural person.

3. The physical distribution management server according to claim 2, wherein data that specifies said natural person, and indicates the contacting method with the natural person, includes e-mail address.

4. The physical distribution management server according to claim 2, wherein data indicating the transport service content, includes any one of, data indicating transfer destination concerning transfer that includes trips and domestic and overseas business trips by the natural person, data indicating a scheduled departure date, data indicating a scheduled arrival date, data indicating size and/or weight of goods that can be transported, and data indicating delivery location and/or way of delivery of goods.

5. The physical distribution management server according to claim 1, wherein said acknowledgement unit receives information concerning the transport service that has reached an agreement between the transport service provider and the transport service user, from a terminal of the transport provider, and acknowledges the transport service whose usage is determined, based on the received information.

6. The physical distribution management server according to claim 1, wherein said information management unit handles transport information whose scheduled departure date according to transfer of the transport service provider, domestically and overseas, has passed, as service provision information that has passed said predetermined retainment period.

7. The physical distribution management server according to claim 1, wherein said insurance performance management unit receives said transport insurance performance data from a computer of an insurance company, via a network.

8. A physical distribution service transaction system having
a physical distribution management server that comprises:
a transport service information reception unit that receives service provision information that includes data for specifying a transport service provider and data indicating transport service content by the service provider, via a network, and retains the information so that it can be browsed via said network;
an acknowledgement unit that acknowledges a transport service that is determined to be used by a transport service user, out of the transport services indicated by the service provision information, based on predetermined information received via said network;
an information management unit that deletes transport service provision information according to said acknowledged service and service provision information that has passed a predetermined retainment period, from the service provision information retained by said transport service information reception unit;
an insurance performance management unit that receives insurance performance data that indicates performance of claim and/or payment of insurance money granted concerning each transport service, based on the usage situation of transport service by the transport service user, via said network, and retains the data so that it can be browsed via said network, and
transport fee payment performance management unit that retains data indicating payment performance of transport fee towards the transport service provider, according to each transport service user, so that it can be browsed, by said network,
a computer of a transport service provider that sends said transport service information to said physical distribution management server, and receives and displays at least one of, transport service information, insurance money performance data, and fee payment performance data, retained by said physical distribution management server, in order to search a transport service that can obtain agreement towards a demand and supply condition, by both the transport service provider and the transport service user, and
a computer of a transport service user that receives and displays at least one of, transport service information, insurance money performance data, and fee payment performance data, retained by said physical distribution management server, in order to search a transport service that can obtain agreement towards a demand and supply condition, by both the transport service provider and the transport service user.

9. The physical distribution service transaction system according to claim 8, wherein said transport service user includes a natural person that carries out transport service individually.

10. The physical distribution service transaction system according to claim 8, wherein the computer of the transport service provider and the computer of the transport service user, uses e-mail to search a transport service that can obtain agreement towards a demand and supply condition, by both the transport service provider and the transport service user.

11. A physical distribution service transaction method comprising:
a step of sending service provision information that includes data for specifying a transport service provider, and data indicating the content of transport service by the service provider, to a physical distribution management sever, via a network;
a step of receiving said service provision information via said network, and retaining the information so that it can be browsed via said network;
a step of acknowledging a transport service that is determined to be used by a transport service user, out of the transport services indicated by the service provision information, based on predetermined information received via said network;
a step of deleting transport service provision information according to said acknowledged transport service and service provision information that has passed a predetermined retainment period, from the retained service provision information;
a step of receiving insurance money performance data that indicates performance of claim and/or payment of insurance money granted concerning each transport service, based on the usage situation of transport service by the transport service user, via said network, and retaining the data so that it can be browsed via said network, and
a step of receiving and displaying at least one of, transport service information insurance money performance data, and fee payment performance data, retained by said physical distribution management server, in order to search a transport service that can obtain agreement towards a demand and supply condition, by both the transport service provider and the transport service user.

12. A computer readable recording medium that stores a program to control a computer to execute:
a step of receiving service provision information that includes data for specifying the transport service provider, and data indicating the content of transport service by the service provider, via a network, and retains the information so that it can be browsed via said network;
a step of acknowledging a transport service that is determined to be used by a transport service user, out of the transport services indicated by the service provision information, based on predetermined information received via said network;
a step of deleting transport service provision information according to said acknowledged transport service and service provision information that has passed a predetermined retainment period, from the retained service provision information;
a step of receiving insurance money performance data that indicates performance of claim and/or payment of insurance money granted concerning each transport service; based on the usage situation of transport service by the transport service user, via said network, and retaining the data so that it can be browsed via said network, and
a step of retaining data indicating payment performance of transport fee towards the transport service provider, according to each transport service user, so that it can be browsed via said network.

13. A computer data signal embedded in a carrier wave, that represents a program for controlling a computer to execute:
a step of receiving service provision information that includes data for specifying the transport service provider, and data indicating the content of transport service by the service provider, via a network, and retains the information so that it can be browsed via said network;
a step of acknowledging a transport service that is determined to be used by a transport service user, out of the transport services indicated by the service provision information, based on predetermined information received via said network;
a step of deleting transport service provision information according to said acknowledged transport service and service provision information that has passed a predetermined retainment period, from the retained service provision information;
a step of receiving insurance money performance data that indicates performance of claim and/or payment of insurance money granted concerning each transport service; based on the usage situation of transport service by the transport service user, via said network, and retaining the data so that it can be browsed via said network, and
a step of retaining data indicating payment performance of transport fee towards the transport service provider, according to each transport service user, so that it can be browsed via said network.
